(19) United States
(12) Patent Application Publication
(10) Pub. No.: US 2013/0314023 A1
(43) Pub. Date: Nov. 28, 2013

(54) WIND ENERGY FAN-TURBINE GENERATOR FOR ELECTRIC AND HYBRID VEHICLES

(71) Applicant: Michael Orlando Collier, Franklin, TN (US)

(72) Inventor: Michael Orlando Collier, Franklin, TN (US)

(21) Appl. No.: 13/901,396

(22) Filed: May 23, 2013

Related U.S. Application Data
(60) Provisional application No. 61/651,919, filed on May 25, 2012.

(51) Int. Cl. B60R 16/03

(52) U.S. Cl. CPC B60R 16/0307
USPC 320/101

(57) ABSTRACT

A wind energy generator for electric and hybrid vehicles can expand the limited driving range of vehicles between charges, reduce the need for petroleum-based products, and reduce or eliminate emissions. The wind turbine utilizes the wind power created by the vehicle traveling at moderate to high speeds. The power created is either used for charging the battery system or it can be stored in the battery system for future use. This expands the driving range of the vehicle before needing recharging and/or additional fuel. The system of the present invention is designed to be compact and discreet, generally incorporating into the vehicle's appearance.

### CROSS-REFERENCE TO RELATED APPLICATION

This application claims the benefit of priority of U.S. provisional application No. 61/651,919, filed May 25, 2012, the contents of which are herein incorporated by reference.

### BACKGROUND OF THE INVENTION

The present invention relates to electricity generation and, more particularly, to a wind energy fan-turbine generator for use on electric and hybrid vehicles.

With electric vehicles, one drawback to consumer acceptance is due to the relatively low distance such a vehicle can be driven before needing to be recharged. With very few charge facilities available and no definitive standards for such charging facilities, it is currently difficult to plan long trips with electric vehicles.

Electric vehicles, as well as hybrid vehicles, are quite popular because they have relatively low emissions (or no emissions for electric vehicles), low operating noise, and reduced fuel costs.

While wind electric generators are known in the art, conventional wind generators are too big and bulky to be used on vehicles and, if included, would detrimentally affect the vehicle's appearance.

As can be seen, there is a need for a method and apparatus to increase the range of electric and hybrid vehicles while not adding substantial bulk or major aesthetic issues.

### SUMMARY OF THE INVENTION

In one aspect of the present invention, a wind energy generator for a vehicle comprises one or more main fans disposed in a front end of the vehicle to receive wind when the vehicle is in motion; one or more copper coils making up an outer periphery of the one or more main fans; magnetic rims disposed on at least outer edges of fan blades making up the one or more main fans, the magnet rims disposed adjacent to the one or more copper coils; and conductive wire carrying power generated in the one or more copper coils to a battery system of the vehicle.

In another aspect of the present invention, a wind energy generator for a vehicle comprises one or more main fans disposed in a front end of the vehicle to receive wind when the vehicle is in motion; one or more lower grill fans disposed to receive wind when the vehicle is in motion; one or more copper coils making up an outer periphery of the one or more main and lower grill fans; magnetic rims disposed on at least outer edges of fan blades making up the one or more main and lower grill fans, the magnet rims disposed adjacent to the one or more copper coils; conductive wire carrying power generated in the one or more copper coils to a battery system of the vehicle; and a power conditioning device receiving the power generated in the one or more copper coils before delivering the power to the battery system.

In a further aspect of the present invention, a method for extending a driving range of an electric vehicle comprises turning one or more main fans in the front end of the vehicle by impinging wind when the vehicle is in motion; generating electricity in one or more copper coils, making up an outer periphery of the one or more main fans, when magnetic rims, disposed on at least outer edges of fan blades making up the one or more main fans, turn adjacent to the one or more copper coils; and carrying power generated in the one or more copper coils to a battery system of the vehicle with conductive wires.

These and other features, aspects and advantages of the present invention will become better understood with reference to the following drawings, description and claims.

### BRIEF DESCRIPTION OF THE DRAWINGS

FIG. 1 is a front view of a vehicle having a wind energy generator disposed therein according to an exemplary embodiment of the present invention;

FIG. 2 is a side view of the vehicle of FIG. 1; and

FIG. 3 is a cross sectional view as taken along line 3-3 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a wind energy generator for electric and hybrid vehicles that can expand the limited driving range of vehicles between charges, reduce the need for petroleum-based products, and reduce or eliminate emissions. The wind turbine utilizes the wind power created by the vehicle traveling at moderate to high speeds. The power created is either used for charging the battery system or it can be stored in the battery system for future use. This expands the driving range of the vehicle before needing recharging and/or additional fuel. The system of the present invention is designed to be compact and discreet, generally incorporating into the vehicle's appearance.

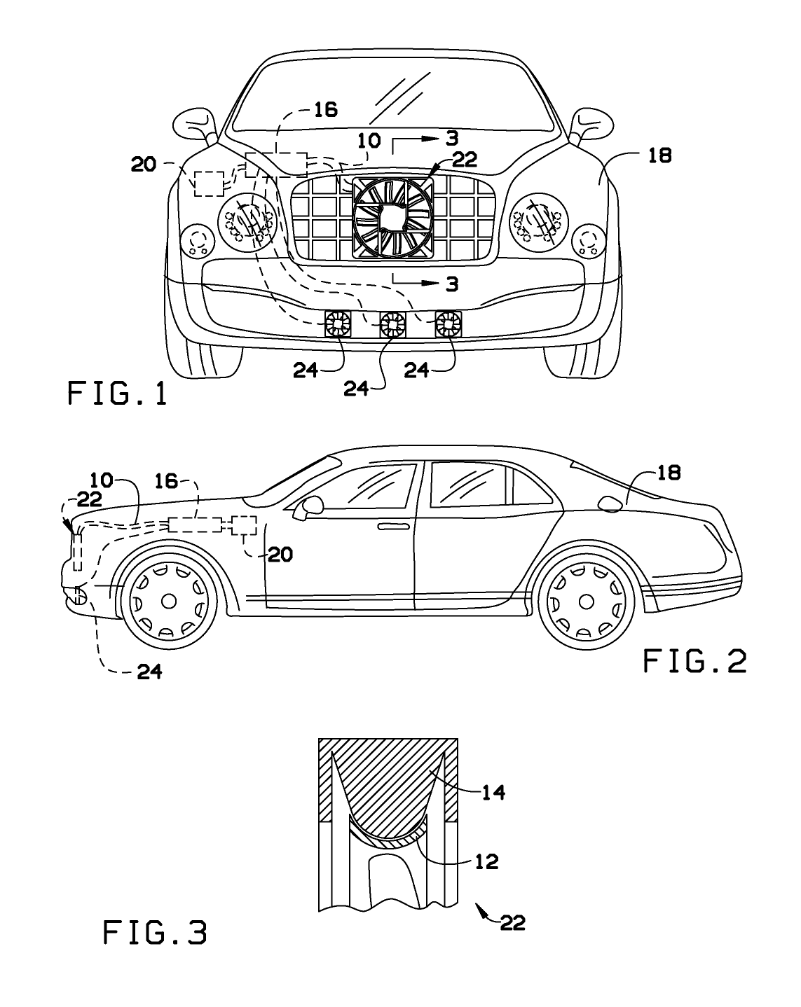

Referring now to FIGS. 1 through 3, a wind energy generator can be mounted in a front end of a vehicle 18. The wind energy generator can include a main fan/turbine 22 and one or more optional lower grill fans/turbines 24. The main fan/turbine 22 can be placed, for example, in a front grill of the vehicle 18 and the lower grill fan/turbine 24 can be placed below the grill in the front of the vehicle 18, as shown in FIG. 1. While FIG. 1 shows one main fan/turbine 22 and three lower grill fans/turbines 24, in some embodiments, more than one main fan/turbine 22 can be used, and none, one, two, three or more lower grill fans/turbines 24 can be used.

In some embodiments, one or more small fans/turbines can be placed in other locations on the vehicle, such as in air intakes or the like.

The fans/turbines 22, 24 can include a conductive coil, such as a copper coil 14 disposed about a periphery of fan blades 26 of the fans/turbines 22, 24. At least the tips of the fan blades 26 can include a magnetic rim 12 operable to generate electricity in the copper coils 14 as the fan blades 26 turn. In some embodiments, as shown in FIG. 3, the magnetic rim 12 can be concave shaped, forming an arc that matches an arc-shape of the copper coils 14.

The fan blades 26 can be driven by wind imparting upon them, typically from movement of the vehicle 18. The electricity generated in the copper coils 14 can be carried to a power conditioning device, such as a power inverter or converter 16 via conductive features, such as wires 10, and delivered to the battery system 20 of the vehicle 18. The generated power can be stored in the battery system 20 or it can be used to power various features of the vehicle, such as electronics, drive train, or the like.

It should be understood, of course, that the foregoing relates to exemplary embodiments of the invention and that modifications may be made without departing from the spirit and scope of the invention as set forth in the following claims.

What is claimed is:

1. A wind energy generator for a vehicle comprises:
one or more main fans disposed in a front end of the vehicle to receive wind when the vehicle is in motion;
one or more copper coils making up an outer periphery of the one or more main fans;
magnetic rims disposed on at least outer edges of fan blades making up the one or more main fans, the magnet rims disposed adjacent to the one or more copper coils; and
conductive wire carrying power generated in the one or more copper coils to a battery system of the vehicle.

2. The wind energy generator of claim 1 further comprises a power conditioning device receiving the power generated in the one or more copper coils before delivering the power to the battery system.

3. The wind energy generator of claim 1 further comprises one or more lower grill fans disposed to receive wind when the vehicle is in motion.

4. The wind energy generator of claim 1 wherein the magnetic rim is concave shaped to match an arc of the one or more copper coils.

5. A wind energy generator for a vehicle, comprising:
one or more main fans disposed in a front end of the vehicle to receive wind when the vehicle is in motion;
one or more lower grill fans disposed to receive wind when the vehicle is in motion;
one or more copper coils making up an outer periphery of the one or more main and lower grill fans;
magnetic rims disposed on at least outer edges of fan blades making up the one or more main and lower grill fans, the magnet rims disposed adjacent to the one or more copper coils;
conductive wire carrying power generated in the one or more copper coils to a battery system of the vehicle; and
a power conditioning device receiving the power generated in the one or more copper coils before delivering the power to the battery system.

6. The wind energy generator of claim 5, wherein the magnetic rim is concave shaped to match an arc of the one or more copper coils.

7. A method for extending a driving range of an electric vehicle, which comprises:
turning one or more main fans in a front end of the vehicle by impinging wind when the vehicle is in motion;
generating electricity in one or more copper coils, making up an outer periphery of the one or more main fans, when magnetic rims, disposed on at least outer edges of fan blades making up the one or more main fans, turn adjacent to the one or more copper coils; and
carrying power generated in the one or more copper coils to a battery system of the vehicle with conductive wires.

8. The method of claim 7 further comprises conditioning power generated in the one or more copper coils before delivering the power to the battery system.

9. The method of claim 7 further comprises turning one or more lower grill fans disposed to receive wind when the vehicle is in motion.
